(19) United States
(12) Patent Application Publication
(10) Pub. No.: US 2024/0351674 A1
(43) Pub. Date: Oct. 24, 2024

(54) Touch Screen Marine Vessel Propulsion Control System

(71) Applicant: Twin Disc, Inc., Racine, WI (US)

(72) Inventor: Michael B. Gee, Kenosha, WI (US)

(21) Appl. No.: 18/640,264

(22) Filed: Apr. 19, 2024

Related U.S. Application Data
(60) Provisional application No. 63/460,387, filed on Apr. 19, 2023.

(51) Int. Cl. B63H 21/21; B63B 49/00; G06F 3/04847; G06F 3/0488

(52) U.S. Cl. CPC B63H 21/21; B63B 49/00; G06F 3/04847; G06F 3/0488

(57) ABSTRACT

A propulsion control system for a marine vessel includes a physical control system and a virtual control system that implements an HMI (human machine interface) that is configured to replicate the manipulations and provide feedback that correlates to manipulations of the physical control system. The virtual control system can dynamically allocate control through the touch screen by giving control to the touch screen by placing it in a control-enabled mode or removing control from the touch screen by placing it in a control-disabled mode. When the virtual control system removes control from the touch screen and places it in the control-disabled mode, the virtual control system may further command the propulsion system to enter a stand-by state in which a transmission is shifted into a neutral range and a prime mover speed is reduced to an idle speed.

### CROSS REFERENCE TO RELATED APPLICATIONS

This application claims the benefit of priority under 35 USC § 119 (e) to U.S. Provisional Patent Application No. 63/460,387, filed Apr. 19, 2023, the entire contents of which are hereby expressly incorporated by reference into the present application.

### BACKGROUND OF THE INVENTION

### Field of the Invention

The preferred embodiments relate generally to the field of marine vessel controls and, more specifically, to a marine vessel propulsion control system that includes a touch screen.

### Discussion of the Related Art

Marine vessel propulsion systems are growing increasingly complex. Within marine vessel propulsion systems, their functional groups, such as engines and transmissions, typically have their own electronic control systems. Efforts to enhance the control of these complex propulsion systems include implementing electronic control devices at user interfaces. Examples include electronic control heads and joysticks that use sensors at the user interfaces and cooperating actuators at the controlled components to control them. Although electronic control heads or joysticks provide control-by-wire capabilities that eliminate the need for various cables or mechanical linkages, they are able to use the same or substantially the same physical grips or knobs as their mechanical counterparts. The physical grips or knobs of these control-by-wire implementations correspondingly offer the same or similar form factor and interactive feel to the user.

Additionally, as touch screen technology advances and associated costs are decreasing, displays that include touch screens are being implemented more frequently in marine vessels. Common marine vessel touch screen implementations include display devices that can graphically present system status or information, typically as representations of gauges. Other common implementations include HMI (human machine interface) devices to operate ancillary or secondary marine vessel systems, such as GPS (global positioning system) or depth/fish finder devices.

However, trying to use touch screens for controlling a vessel's propulsion functions presents numerous challenges. Some of the challenges relate to the dynamically changing environments in which vessels operate. Environmental influences such as wind, water current, and wakes from other vessels, can cause a vessel to drift or otherwise move. The environmentally-induced vessel movements can require a substantial amount of control device manipulation to overcome. This is especially true while performing high-precision vessel maneuvers, such as docking maneuvers or location holding maneuvers to maintain a constant position/heading. While performing such high-precision vessel maneuvers, many users try to continuously watch the vessel and its surroundings and manipulate the controls mostly by feel. Yet touch screens typically require closely looking at them for accurate use and do not provide physical structures that can offer spatial or positional information of those structures, making it difficult to operate touch screens by feel.

Furthermore, the environmentally-induced vessel movements can force users to physically work to actively maintain their balance. As a result, it can be difficult to accurately manipulate a touch screen while simultaneously actively working to maintain one's balance. Resulting mis-swipes or other instability-induced accidental touch screen engagements can compromise the accuracy of input delivery through a touch screen.

What is therefore needed is a vessel propulsion control system that can implement a touch screen that more closely replicates corresponding manipulations of physical controls.

### SUMMARY AND OBJECTS OF THE INVENTION

The preferred embodiments overcome the above-noted drawbacks by providing a marine vessel propulsion control system that includes a physical control system and a virtual control system. The virtual control system implements an HMI (human machine interface) with a touch screen to control a marine vessel's propulsion system with virtual control features that are analogous to corresponding control features of the physical control system. The virtual control features may be presented through the touch screen as features of a GUI (graphical user interface) that two-dimensionally recreates the general movements and feel of the counterpart physical control devices. The HMI may provide feedback to convey positional information about the virtual control features.

In some implementations, the touch screen may provide the feedback as at least one of haptic feedback that can be felt, audible feedback that can be heard, or visual feedback that can be seen by the user. This may allow users to know the virtual control devices' positions, without looking or with less focused visual confirmation than would otherwise be required.

In some implementations, the touch screen may deliver feedback as an aspect of a virtual detent feature defined at a virtual detent position. Feedback may be delivered to inform a user when a movable virtual control device has been moved to and/or through a virtual detent position.

In some implementations, a different touch-based interaction or engagement with the touch screen is required to move the virtual control device past the virtual detent than is required to move it through the rest of its range of motion. Moving a virtual control device past a virtual detent may require, for example, at least two fingers on the touch screen, removing or reapplying a finger(s) from the touch screen, and/or maintaining a finger in a specific target location while dragging another finger(s) to move the virtual control device past the virtual detent. After moving past or overcoming the virtual detent, further movement of the virtual control device may be achieved with a simpler finger dragging, without the confirmatory second finger touch or tap. Pressure sensitive touch screens may require greater pressure application into the touch screen while finger dragging to move the virtual control device past the detent than is required move it through the rest of its range of motion.

In some implementations, the touch screen may deliver feedback to convey where a virtual control device is positioned in the GUI within its virtual range of motion. The touch screen may deliver variable feedback that changes as a function of the virtual control device's movement. As the virtual control device is being moved through its range of motion, and thus further from its neutral or default position, the feedback may be delivered with, for example, greater intensity.

In some implementations, various characteristics of the virtual control system can be programmed or redefined. The number and/or position of virtual detents for the different virtual control devices may be programmed or redefined by the user. The scale of range of motion or the control resolution for moving the virtual control devices to perform propulsion operations may also be programmed or redefined by the user.

In some implementations, different virtual control devices may be presented at different times through the touch screen for performing the control operations of corresponding different physical control devices. The user may select a different virtual control device through the touch screen, which presents a corresponding GUI that displays the respective virtual control device.

In some implementations, the virtual control system can dynamically allocate control through the touch screen. The virtual control system can give control to the touch screen by placing it in a control-enabled mode or remove control from the touch screen by placing it in a control-disabled mode. When the virtual control system removes control from the touch screen and places it in the control-disabled mode, the virtual control system may further command the propulsion system to enter a stand-by state. This can include commanding a transmission to shift into a neutral range and reducing an engine speed to an idle speed. The stand-by state may instead implement a station keeping mode in which the propulsion control maintains the vessel's location and/or heading until a user actively resumes control or confirms control of the vessel to exit the stand-by state.

In some implementations, the virtual control system takes away control from the touch screen if it determines that the touch screen has been dropped. An accelerometer or other sensor may provide a signal that is evaluated by the virtual control system to identify a drop event of the touch screen. Upon determining that the touch screen has been dropped, the virtual control system may command the propulsion system to enter the stand-by state by shifting its transmission into neutral and reducing engine speed to idle.

In some implementations, the virtual control system may be configured to distinguish a user's purposeful commands through the touch screen and accidental interactions with the touch screen. This may be done by identifying touch-based engagement of the touch screen and evaluating characteristics of these potential command inputs using a set of rules that correlate such characteristics as being consistent with either purposeful or true command inputs or accidental or null command inputs. Based on this potential command input evaluation(s), the virtual control system executes the true commands and ignores the null commands. The set of rules used in evaluating the potential command inputs may provide acceptable or target values for such criteria as position or zones or acceptable touch-based engagement of the touch screen or speed(s) of swiping or other engagements of the touch screen.

These, and other aspects and objects of the present invention, will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical embodiments of the present invention, will become more readily apparent by referring to the exemplary and, therefore, non-limiting, embodiments illustrated in the drawings accompanying and forming a part of this specification, wherein like reference numerals designate the same elements in the several views, and in which:

FIG. 1 is a schematic illustration of marine vessel implementing a touch screen marine vessel propulsion system, according to a preferred embodiment;

FIG. 2 is a schematic illustration of a propulsion control system implementing a physical and virtual control systems, according to another preferred embodiment;

FIG. 3-4 are schematic illustrations of aspects of a virtual control system, according to another preferred embodiment;

FIGS. 5-8 are other schematic illustrations of aspects of a virtual control system, according to another preferred embodiment;

FIGS. 9-10 are other schematic illustrations of aspects of a virtual control system, according to another preferred embodiment;

FIGS. 11-13 are other schematic illustrations of aspects of a virtual control system, according to another preferred embodiment;

FIGS. 14-15 are other schematic illustrations of aspects of a virtual control system, according to another preferred embodiment; and

FIG. 16 is a flow diagram showing a procedure for adjusting various parameters of a virtual control system, according to another preferred embodiment.

In describing preferred embodiments of the invention, which are illustrated in the drawings, specific terminology will be resorted to for the sake of clarity. However, it is not intended that the invention be limited to the specific terms so selected, and it is to be understood that each specific term includes all technical equivalents, which operate in a similar manner to accomplish a similar purpose. For example, the words “connected”, “attached”, “coupled”, or terms similar thereto are often used. They are not limited to direct connection but include connection through other elements where such connection is recognized as being equivalent by those skilled in the art.

### DETAILED DESCRIPTION OF PREFERRED EMBODIMENTS

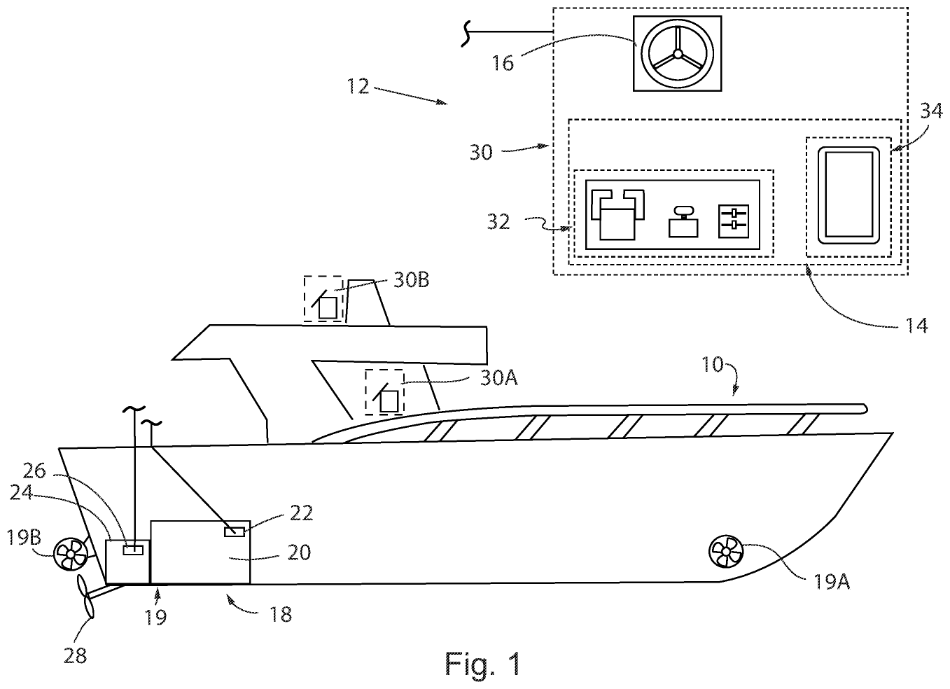

Referring to FIG. 1, one embodiment of the invention is shown in a marine vessel 10 with a vessel control system 12 that implements a touch screen marine vessel propulsion control system, shown as propulsion control system 14 that provides virtual control devices to correspond to related physical control devices. Vessel control system 12 includes a steering system 16 that is configured primarily for steering or changing a heading of vessel 10, whereas propulsion control system 14 is primarily configured to control the vessel's propulsion system 18 that propels the vessel 10. Propulsion control system 14 may be implemented as or includes various components of a marine propulsion control system, such as the EC600PC advanced electronic propulsion control system available from Twin Disc, Inc. of Racine Wisconsin.

Still referring to FIG. 1, propulsion system 18 includes at least one drive 19 having a prime mover and associated power transmission device, such as transmission that may be implemented as a mechanical gearbox that may further include a clutch(es), torque converter(s), or the like. The prime mover is represented here as an internal combustion engine 20 with an engine controller 22, although it is understood that the prime mover may instead be or include an electric motor as an electric and/or hybrid type propulsion system 18. It is understood that in electric motor implementations of the prime mover, the motor itself may provide the power transmission device, such as with its output shaft or that of an integrated gearbox at its output section. Within each drive 19, engine 20 delivers power to transmission 24, which may be one of a marine transmission such as an MG-series or MGX-series transmission (QuickShift® transmission) with a modulatable clutch available from Twin Disc, Inc. Transmission 24 includes a transmission controller 26 and is configured to rotate a propeller 28. The engine controller 22, transmission controller 26, and other controllers within the vessel control system 12 and propulsion control system 14 include computers that execute various stored programs while receiving inputs from user commands and/or sensors, and sending commands to various control subsystems or components, which include actuators, in the respective functional units. Communication between the systems and components may be done through a CAN-BUS (controller area network bus) that interconnects the systems and components and conveys the instructions to control, for example, engine speed of engine 20 and transmission clutch engagement and range selection of transmission 24 based on instructions delivered by the engine controller 22 and transmission controller 26. Propulsion system 18 may include other components that are configured for lateral-type propulsion, such as bow thruster 19A and stern thruster 19B, which have propellers that are arranged transversely with respect to the hull's centerline. Each of the bow and stern thrusters 19A, 19B is shown here with a tunnel configuration, with bow thruster 19A extending transversely through the hull's bow and stern thruster 19B mounted externally to the hull's stern.

Still referring to FIG. 1, vessel 10 includes at least one control station 30, shown here as main control station 30A and secondary or upper control station 30B. Each control station 30A, 30B may provide interfaces for a physical control system 32 and a virtual control system 34 within the propulsion control system 14 for controlling the propulsion system 18.

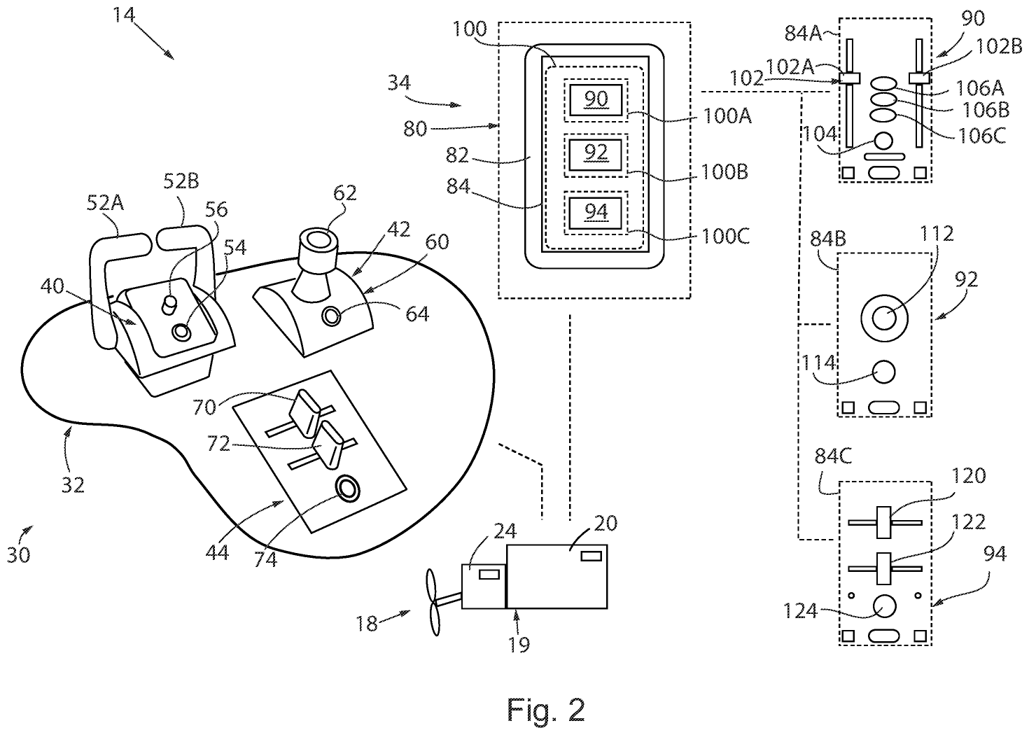

Referring now to FIG. 2, physical control system 32 has a set of physical control devices that a user can physically actuate or otherwise manipulate to control operations of the propulsion system 18. The set of physical control devices is shown here as including a control head 40, joystick device 42, and thruster control device 44. The control head 40, joystick device 42 and thruster control device 44 may be respectively implemented as a control head, EJS® (Express Joystick System), and Veth Thruster System available as various subsystems and components of the EC600PC advanced electronic propulsion control system available from Twin Disc, Inc.

Still referring to FIG. 2, the illustrated control head 40 has at least one moveable control mechanism, shown as a pair of levers 52A, 52B, which may be configured to respectively control port and starboard drives 19 (only one shown) of propulsion system 18. Each lever 52A, 52B can be moved past a detent such as a neutral detent that holds the lever 52A, 52B in a neutral position with the transmission in a neutral range and the engine at an idle speed. Moving the lever(s) 52A, 52B forward past its neutral detent shifts the transmission 24 into a forward range and may be associated with a mechanical click-type feel as the lever 52A, 52B passes the detent. The distance from which lever 52A, 52B is moved forward past the neutral detent corresponds to a commanded engine speed, with a further forward movement of the lever 52A, 52B providing a greater engine speed. Moving lever 52A, 52B rearward past its neutral detent shifts the transmission 24 into a reverse range. Like shifting the drive's transmission 24 into its forward range, when shifted into its reverse range, the distance from which the lever 52A, 52B is moved rearward beyond the neutral detent provides a corresponding increase in engine speed.

Still referring to FIG. 2, control head 40 of physical control system 32 may include a station select button 54 that is configured to facilitate station transfer or specific station control. When a user presses the station select button 54, the propulsion control system 14 activates to receive command inputs from the particular control head 40 at its corresponding control station 30, such as the main or upper control station 30A, 30B (FIG. 1). Typically, pressing the station select button 54 causes the propulsion control system 14 to perform a “take from” type control transfer function, which transfers control to the particular control station 30 at which the station select button 54 was pressed, if the active control station was different than where the station select button 54 was pressed. Mode selector 56, shown here as a mode selector knob, is configured to receive user input to select a particular operational mode for the propulsion system 18. Different modes may include, for example, one or more cruise modes, sync mode, express mode, troll mode, and/or lever synch mode, such as those available within the management suite of the EC600PC advanced electronic propulsion control system available from Twin Disc, Inc. of Racine Wisconsin. The different modes available through mode selector 56 provide different, for example, control resolutions or control characteristics, including different operational characteristics defined between multiple adjacent detents within the lever movement range(s), that allow for different precision in propulsion and maneuvering control to accommodate different water, wind, and/or other conditions.

Still referring to FIG. 2, joystick device 42 includes a joystick base 60 that is mounted to, e.g., a dash or instrument panel. Joystick 62 extends as a movable control mechanism from the base 60 and may be implemented with a dual axis, triple axis, or other multi-axis configuration. Joystick 62 is movable with multiple degrees of freedom, such as along X, Y, and/or Z axes, and can be rotated or twisted to receive user inputs. These movements of joystick 62 allow for providing inputs to command vessel movements that correspond to straight ahead, straight reverse, lateral, diagonal, or rotate/yaw vessel movements. The joystick device typically includes a neutral detent, which may be implemented as a position restoring device that applies a biasing force to restore the joystick 62 to a neutral position that does not provide an input for a propulsion system operational command. In this way, manipulation of joystick 62 is typically configured as a return-to-center momentary control that requires continuous holding or manipulation to maintain the command instruction for performing the vessel maneuver. Like the station select button 54 of control head 40, joystick device 42 may include a station select button 64 that is configured to transfer control to the respective control station 30.

Continuing to refer to FIG. 2, thruster control device 44 of the physical control system 32 includes at least one single axis joystick as a movable control mechanism, shown here with two single axis joysticks that are implemented as slider-type levers, such as bow thruster lever 70 and stern thruster lever 72. Each of the bow and stern thruster levers 70, 72 can be slid from a center, neutral, position to the left or to the right. Sliding the thruster lever 70, 72 to the left provides an input to command the respective bow or stern thruster(s) 19A, 19B (FIG. 1) to activate and push the respective bow or stern segment in a port direction. Sliding the thruster lever 70, 72 to the right provides an input to command the respective bow or stern thruster(s) 19A, 19B (FIG. 1) to activate and push the respective bow segment in a starboard direction. The thruster control device 44 may also have neutral detents, typically implemented as position restoring device for each thruster lever 70, 72 to restore it to its neutral position, providing a return-to-center momentary control configuration for the thruster lever 70, 72. Like the station select buttons 54, 64 of the control head 40 and joystick device 42, thruster control device 44 may include a station select button 74 that is configured to transfers control to its particular control station 30.

Virtual control system 34 includes an HMI (human machine interface) 80 that is shown implemented as a touch screen 82. The touch screen 82 may be a stand-alone device at each control station 30 or a single touch screen(s) 82 may be wirelessly connected to the propulsion control system 14 by way of suitable wireless communications protocols such as Bluetooth®, Wi-Fi, cellular, or other WLAN (wireless local area network) systems. The wireless communications between touch screen 82 and the propulsion control system allow the touch screen 82 to be moved between different control stations 30 or elsewhere on vessel 10 (FIG. 1) and maintain the vessel's operational control. Typically, touch screen 82 is implemented as a smart device, such as a smart phone or a smart tablet, with the various HMI features implemented through an app(s) that presents GUIs (graphical user interface) 84 with graphical representations of control devices, such as the control head 40, joystick device 42, and thruster control device 44 of the physical control system 32.

Still referring to FIG. 2, GUIs 84 are shown here as control head GUI 84A, joystick device GUI 84B, and thruster control device GUI 84C that provide graphical representations of control head 40, joystick device 42, and thruster control device 44 and provide the interfaces for corresponding virtual control devices. The GUIs 84A, 84B, 84C, provide virtual movable control mechanisms of virtual control devices that correspond to respective movable control mechanisms of their physical control device counterparts. One such virtual control device is shown as virtual control head 90 that corresponds to control head 40 of the physical control system 32. Virtual joystick device 92 corresponds to joystick device 42 of the of the physical control system 32. Virtual thruster control device 94 corresponds to thruster control device 44 of the physical control system 32. The virtual control system's 34 virtual control devices 90, 92, 94 present graphical features in their GUIs 84A, 84B, 84C that perform respective actions of their physical counterparts in the physical control system 32.

On the GUI 84A of virtual control head 90, at least one virtual lever 102, shown here as a pair of virtual levers 102A, 102B, are presented as images that correspond to the respective physical levers 52A, 52B and are moveable by touch-engagements with the touch screen 82, such as finger(s) dragging. Movements of the virtual levers 102A, 102B issues corresponding command inputs to the propulsion control system 14 as the respective movements of the physical control levers 52A, 52B. Virtual station select button 104 can be pressed to transfer control to the virtual control head 90 that is displayed through touch screen 82. If the touch screen 82 is not already in a control-enabled mode, pressing the virtual station select button 104 transitions the touch screen 82 into its control-enabled mode as part of the control transfer procedure. Mode buttons 106A, 106B, 106C are configured to be pressed to select different operational modes, such as those available through the physical control system's mode selector knob 56.

Still further in FIG. 2, on the GUI 84B of virtual joystick device 92, virtual joystick 112 is presented as an image that corresponds to the physical joystick 62, as a virtual multi-axis joystick. The virtual joystick 112 can be moved through touch-engagements with the touch screen 82, such as finger(s) dragging for linear movements or twisting-type motions to impart rotations of the virtual joystick 112. The movements of the virtual joystick 112 issues corresponding command inputs to the propulsion control system 14 as respective movements of the physical joystick 62. Pressing the virtual station select button 114 transfers control to the virtual joystick device 92 that is displayed through touch screen 82, which may also include commanding the touch screen 82 to enter its control enabled mode.

On the GUI 84C of virtual thruster control device 94, at least one virtual single axis joystick is provided. The virtual thruster control device 94 is shown here with two virtual single axis joysticks as a virtual bow thruster lever 120 corresponds to the physical bow thruster lever 70 and virtual stern thruster lever 122 corresponds to the physical stern thruster lever 72. Each of the virtual thruster levers 120, 122 can be moved through touch-engagements with the touch screen 82, such as by finger dragging. Movements of the virtual thruster levers 120, 122 to the left and right provide corresponding command inputs to the propulsion control system 14 as left and right sliding movements of the physical thruster levers 70, 72. Pressing the virtual station select button 124 transfers control to the virtual thruster control device 94 that is displayed through touch screen 82, which may also include commanding the touch screen 82 to enter its control enabled mode.

Continuing to refer to FIG. 2, the GUI 84 may present a home page 100 with icons 100A, 100B, 100C that can be pressed to select which particular virtual control device 90, 92, 94 to activate and present its respective GUI 84A, 84B, 84C on the touch screen 82. Yet other GUIs may provide menu displays for selecting other aspects of the virtual control system 34, such as various settings and/or customization features to (re) configure or (re) define different control, display, and/or other parameters or operational characteristics. These may include adding, removing, or repositioning virtual detents to the virtual devices, as well as adding, removing, or redefining delivery of feedback that the virtual control system 34 delivers to the user.

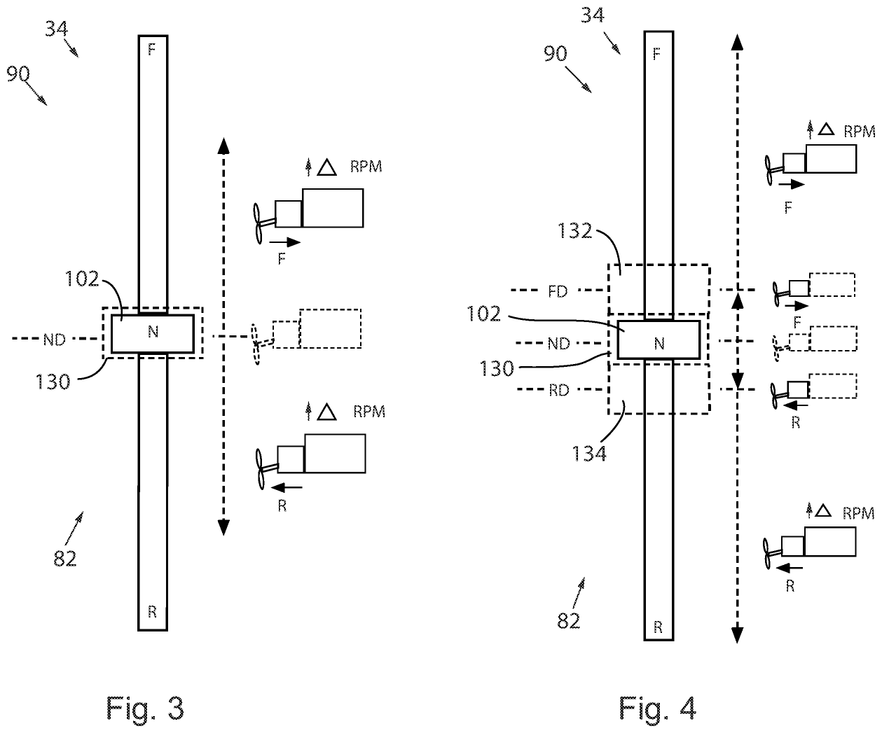

Referring generally to FIGS. 3-4, examples of virtual detents are shown here implemented with the virtual control head 90. The virtual control head 90 of FIG. 3 includes a single virtual detent, whereas the virtual control head 90 of FIG. 4 includes three virtual detents. Referring now to FIG. 3, the virtual detent is shown as virtual neutral detent 130. A default position of virtual control lever 102 is in its neutral location, in which the virtual control lever 102 is held at the detent position of the virtual neutral detent 130. Movement of the virtual control lever 102 out of or past any virtual detent position requires a different type of input, a detent-overcoming input, than is required to move the virtual control lever 102 through other portions of its range of motion, such as a control input. Typically, a detent-overcoming input is more complex than the subsequent control input. Examples of detent-overcoming inputs may include at least two fingers touch-engaging an appropriate location(s) on the touch screen 82, finger(s) removal and/or tapping sequence, whereas the control input may be more straight forward or a simpler manipulation such as single-finger dragging or single taps to move the virtual control lever to the corresponding potion(s). The different types of input for detent-overcoming inputs and control inputs allow the virtual control system 34 to evaluate potential control command inputs to determine whether they are true command inputs that should be executed as a true command or ignored as a null command. For true commands, the virtual control system 34 evaluates the type of command, distinguishing between a detent-overcoming command that is required to move the virtual control lever 102 past the virtual detent or otherwise along its range of motion.

Still referring to FIG. 3, when a detent-overcoming input is delivered through the touch screen 82 that moves the virtual control lever 102 forward past the neutral detent 130, the virtual control system 34 issues a command(s) to the propulsion system 18 (FIG. 2) to shift the drive's 19 transmission 24 (FIG. 2) into its forward range. In this example, the engine's 20 (FIG. 2) speed is simultaneously increased as a function of the distance from which the virtual control lever 102 is moved from the virtual neutral detent 130. Once the virtual control lever 102 has been moved past the virtual neutral detent 130, a different type of user input through touch-engagement with touch screen 82 may be sufficient to continue moving the virtual control lever 102 relative to the virtual neutral detent 130. The same shifting and engine speed control occurs when a detent-overcoming input is delivered through the touchscreen 82 to move the virtual control lever 102 rearwardly of the virtual neutral detent 130, only the virtual control system 34 commands a shift of the drive's 19 transmission 24 into its reverse range.

Referring now to FIG. 4, in addition to the virtual neutral detent 130, two additional virtual detents are arranged at respective virtual detent positions within the virtual control lever's 102 range of motion. These are shown as virtual forward detent 132 and virtual reverse detent 134 that are juxtaposed with respect to or immediately adjacent virtual neutral detent 130. These three virtual detents as virtual neutral, forward, and reverse detents 130, 132, 134, may be configured to define discrete idle detent positions that provide corresponding transmission range selection while maintaining engine idle speed. For example, in this configuration, as soon as the virtual control lever 102 exits the virtual neutral detent 130, it immediately enters one of the other idle detent positions. In the virtual control head 90 shown in FIG. 4, moving the virtual control lever 102 forward or above the virtual neutral detent 130 immediately moves or virtually snaps the virtual control lever 102 into the virtual forward detent 132 position. Moving the virtual control lever 102 rearward or below the virtual neutral detent 130 immediately moves or virtually snaps the virtual control lever 102 into the virtual reverse detent 134 position. Further movement in either direction past the respective virtual forward and reverse detents 132, 134 increases engine speed and/or clutch engagement depending on the selected mode of operation.

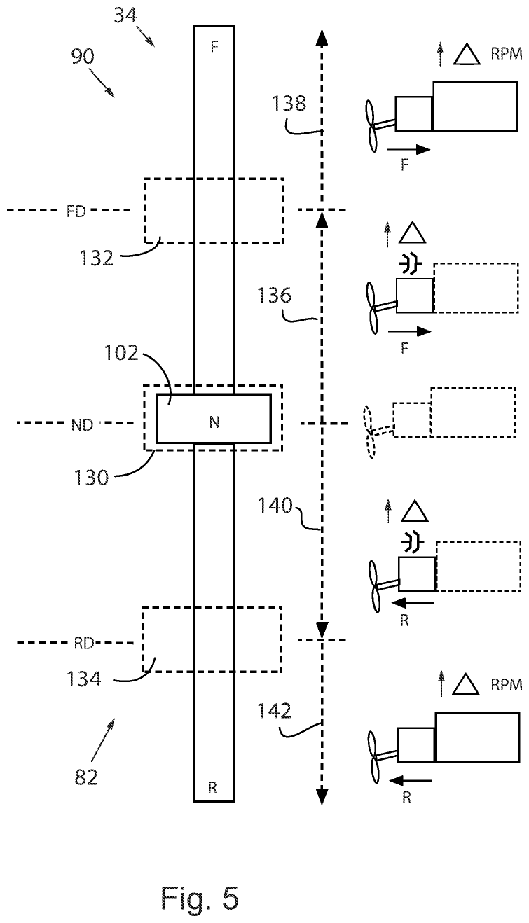

Referring now to FIG. 5, in this example, the virtual forward detent 132 and virtual reverse detent 134 are spaced from the virtual neutral detent and shifting out of the transmission's neutral range does not automatically virtually snap the virtual control lever to either the virtual forward or reverse detent 132, 134 position. In this example, within the virtual control lever's 102 range of motion, a clutch modulation segment is defined between the virtual neutral detent 130 and the virtual forward detent 132 as forward modulation segment 136. After the virtual control lever 102 is released from the virtual neutral detent by way of the detent-overcoming input, the transmission 24 (FIG. 2) is shifted into its forward range.

Still referring to FIG. 5, movement of the virtual control lever 102 away from the neutral detent 130 through the forward modulation segment 136 modulates a clutch of the transmission 24 (FIG. 2) to increase its engagement as the virtual control lever 102 advances away from the virtual neutral detent 130 until it arrives at the forward virtual detent 132. This is typically done with the engine 20 (FIG. 2) maintaining an idle speed. The virtual control lever 102 is unable to advance past the virtual forward detent 132 unless the user delivers another detent-overcoming input through the touch screen 82.

Continuing to refer to FIG. 5, in this example, a forward engine throttle segment 138 is defined beyond the virtual forward detent 132 and the forward modulation segment 136, between the virtual forward detent 132 and the end of the virtual control lever's 102 range of motion. After the virtual control lever 102 is released from the virtual forward detent 132 by way of the detent-overcoming input, the transmission 24 (FIG. 2) remains in its forward range and the transmission's 24 (FIG. 2) clutch is fully engaged. Further forward movement of the virtual control lever 102 beyond the virtual forward detent 132 provides a command to vary the engine speed that progressively increases the engine's RPM as the virtual control lever 102 is moved further from the virtual forward detent 132.

Still referring to FIG. 5, from virtual neutral detent 130, shifting into reverse is the same as described regarding shifting into forward, only the transmission 24 (FIG. 2) is shifted into its reverse range. A user applies a detent-overcoming input to the touch screen 82 to move the virtual control lever 102 rearward past the virtual neutral detent 130 and into a reverse modulation segment 140. When moving the virtual control lever 102 through the reverse modulation segment 140, the engine 20 (FIG. 2) remains in idle, the transmission 24 (FIG. 2) is shifted into its reverse range, and the transmission's clutch is modulated to increase engagement as the virtual control lever 102 is moved further from the virtual neutral detent 130 until it arrives at the virtual reverse detent 134. To move the virtual control lever past the virtual reverse detent 134 and into a reverse engine throttle segment 142, the user applies another detent-overcoming input through the touch screen 82. As the user moves the virtual control lever 102 through the reverse engine throttle segment 142, the transmission remains in its reverse range with its clutch fully engaged and further movement of the virtual control lever 102 away from the virtual reverse detent 134 correspondingly increases the engine RPM.

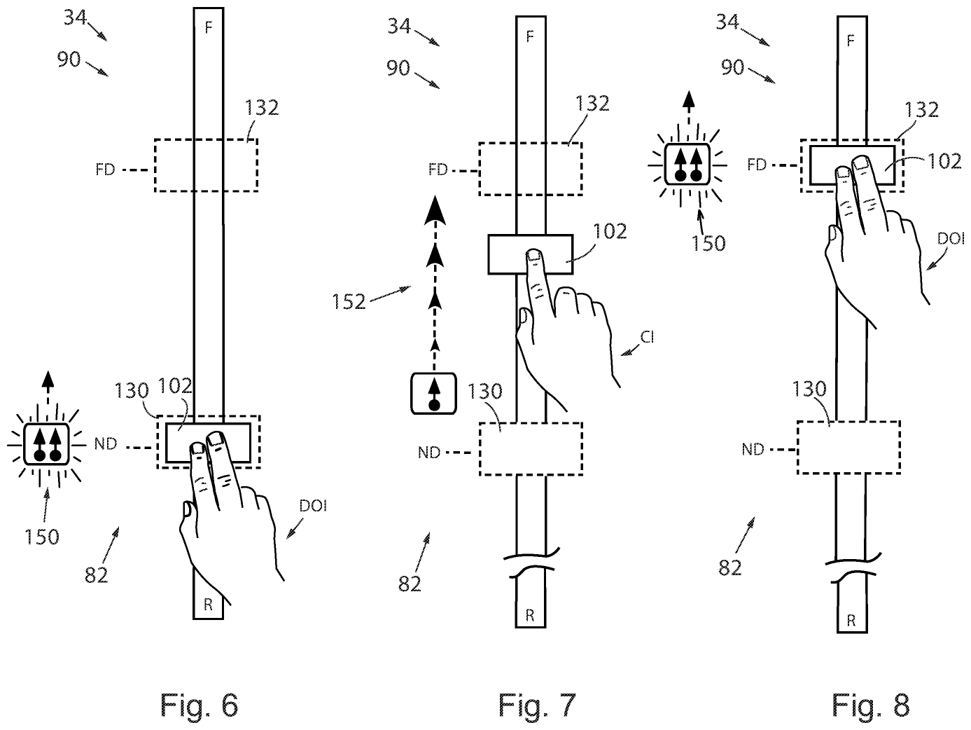

Turning to FIGS. 6-8, the HMI 80 (FIG. 2) provides feedback to the user to convey positional information about the virtual control devices or features, shown by way of the virtual control head 90 displayed on touch screen 82. Referring now to FIG. 6, a user's application of a detent-overcoming input (“DOI”) through a touch engagement with the touch screen 82 is shown. The detent-overcoming input DOI in this example is touching or pressing the virtual control level 102 with two fingers and sliding the fingers forward to drag the virtual control lever 102 past the virtual neutral detent 130. When the virtual control lever 102 is released from and moves past the virtual neutral detent 130, the virtual control system 34 commands the touch screen 82 to deliver feedback to the user, represented as detent feedback 150. Detent feedback 150 may include a delivery of haptic stimulus through the touch screen 82 in a manner that the user can perceive as a click to inform the user that the virtual neutral detent has been overcome.

Referring now to FIG. 7, at that point, the user can move the virtual control lever 102 through at least partially through its range of motion by way of a different type of input, typically less complex or dexterous, such as a control input (“CI”). The control input CI in this example is touching or pressing the virtual control lever 102 with a single finger and sliding the finger forward to drag the virtual control lever 102 away from the virtual neutral detent 130. The virtual control system 34 may command the touch screen 82 to deliver feedback that conveys positional information of the virtual control lever 102 to the user during its movement imparted by the control input CI, represented here as control position feedback 152. Control position feedback 152 may also be delivered as haptic stimulus that can be felt and be delivered in a variable manner. As the virtual control lever 102 is moved further from the virtual neutral detent 130, the touchscreen 82 may deliver the control position feedback with increasing intensity. This may include, for example, increasing firmness of clicks or increasing frequency of clicks or vibrations and the virtual control lever 102 moves forward, shown here approaching the virtual forward detent 132.

Referring next to FIG. 8, when the virtual control lever 102 reaches the virtual forward detent 132, further application of the control input CI (FIG. 6) will not move the virtual control lever 102 past the virtual forward detent 132. Instead, another application of a detent-overcoming input DOI is required to overcome and move past the virtual forward detent 132. Like moving past the virtual neutral detent 130 (FIG. 5), when the virtual control lever 102 is moved past the virtual forward detent 132, the virtual control system 34 commands the touch screen 82 to deliver detent feedback 150. Although the same detent feedback 150 is shown when the virtual control lever 102 overcomes both the virtual neutral detent 130 and the virtual forward detent 132, it is understood that different types or intensities of feedback stimulus may be delivered for overcoming different types of virtual detents. Typically, every virtual detent position requires a new discrete DOI to move out of its position, so the DOI is required each time that the virtual control lever 102 (or other virtual control device) reaches a detent position. In the example shown in FIGS. 6-8, the virtual control system 34 may be configured so that if the DOI is an application of two fingers to move the virtual control lever 102, the user cannot then, with two fingers continuously applied to the touch screen 82, move back and forth through the entire range of motion. Once another virtual detent is reached, the two fingers must be removed and re-applied to continue lever movement.

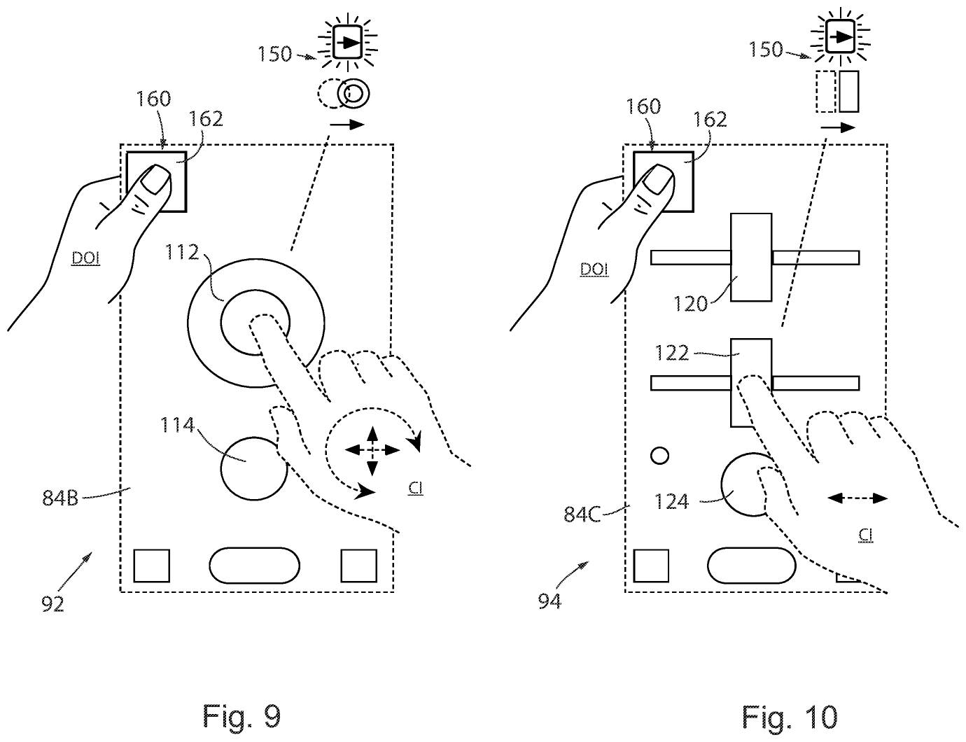

Referring now to FIGS. 9-10, the description of virtual detents and feedback implemented with virtual control head 90 (FIGS. 3-8) applies equally to other types of the virtual control system's virtual control devices, including virtual joystick devices 92 (FIG. 9) and virtual thruster control devices 94 (FIG. 10). Although movements paths of the virtual features of the joystick device 92 (FIG. 9) and virtual thruster control device 94 (FIG. 10) may differ from those of the virtual control lever 102 (FIGS. 3-8), each movable virtual control device or feature may define neutral or other detent positions that require different types of input to overcome or move past than other segments or the remainder(s) of their corresponding ranges of motion.

Still referring to FIGS. 9-10, the virtual joystick device 92 (FIG. 9) and the virtual thruster control device 94 (FIG. 10) are shown a virtual neutral detent 160 that includes a continuous hold area 162. A user presses or touches and maintains contact with the continuous hold area 162 for the virtual control system 34 to allow the virtual detent to be overcome or moved past by the virtual joystick 112 (FIG. 9) or virtual thruster lever(s) 120, 122 (FIG. 10). When implemented with a continuous hold area 162, the detent-overcoming input DOI and the control input CI may be applied at the same time that requires a constant press or touch through touch screen 82 as a detent-overcoming input DOI.

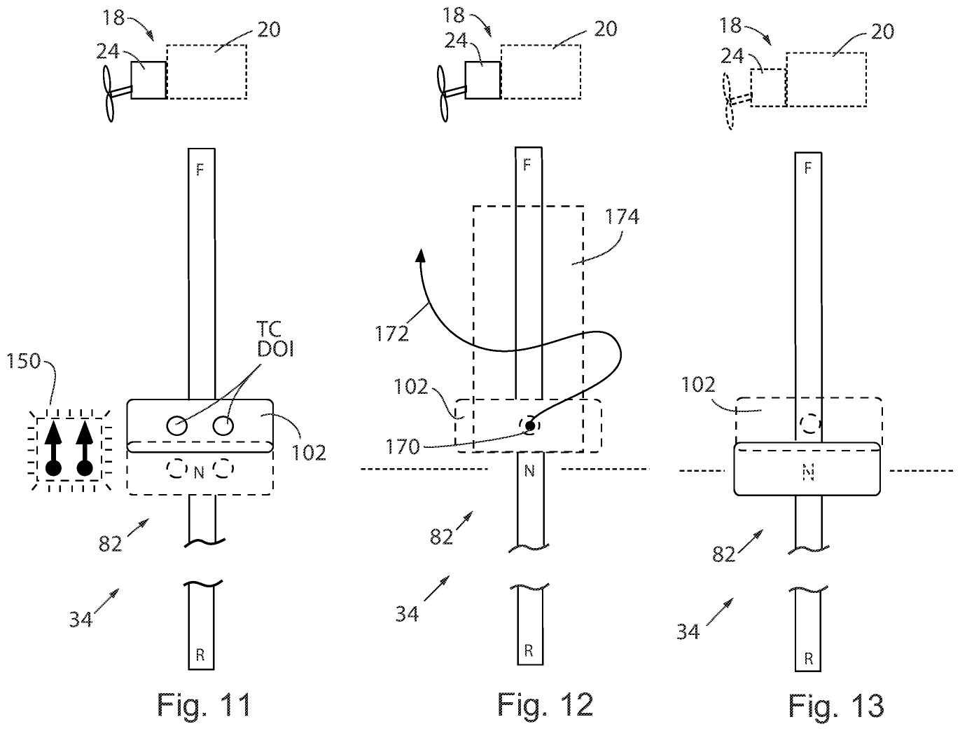

Referring now generally to FIGS. 11-15, virtual control system 34 is configured to perform dynamic control allocation based on assessments of whether a user is suitably in control. This may include ignoring various interactions with the touch screen 82 when the touch screen 82 is in its control-enabled mode and/or entirely removing control from the touch screen 82, which may include placing the touch screen into a control-disabled mode.

Referring to FIGS. 11-13, the control system 34 is configured to evaluate potential command inputs and determine whether the potential command input is a true command input that corresponds to a user's desired command to control an operation of the marine vessel propulsion system 18 or a null command input that corresponds to an ancillary touch-based engagement of the touch screen that is not indicative of the user's desired command. In FIG. 11, the user shifts the virtual control lever 102 into its forward range from the neutral range, overcoming the virtual neutral detent 130. In this example, virtual control system 34 receives a signal(s) from touch screen 82 that corresponds to two fingers touching the virtual control lever 102 and sliding it forward. The virtual control system 34 determines that such a double finger touch and forward slide is a sufficient detent overcoming input DOI as a true command (“TC”) input by, for example, comparing the touch characteristics and associated values with saved values or ranges of acceptable values, and commands the propulsion system 18 to shift the transmission 24 into its forward range. The virtual control system 34 also delivers detent feedback 150, indicating that the transmission 24 has been shifted into its forward range.

Referring now to FIG. 12, a potential command may have initial characteristics of a true command input, such as a control input CI-type single finger touch engagement of the virtual control lever 102, yet overall characteristics that demonstrate that it was not a true command, but rather a null command. In this example of a potential command input, an engagement point 170 is defined at a location at which a single finger contacts the touch screen 82, which may typically correspond to an appropriate single finger control input. However, as represented by the curved sliding path line 172 along which the user's finger slid, the touch engagement of the user's finger with the touch screen 82 strayed outside of an acceptable sliding path zone 174 and the virtual control system 34 correspondingly determines that the potential command input is an accidental instruction or null input. In response, the virtual control system 34 does not issue any further command of operation of the propulsion system 18 based on the touch engagement of the touch screen 82 that traced the curved sliding path line 172. As shown in FIG. 12, the transmission 24 may remain shifted in its forward range, but the engine 20 remains at an idle speed. It is understood that virtual control system 34 may evaluate other criteria to determine whether a potential command input is a true command or a null command, such as evaluating time or speed-based values, including swipes that occur too quickly compared to acceptable values corresponding to null commands. As shown in FIG. 13, if the virtual control system 34 determines that the touch engagement with touch screen 82 is sufficiently anomalous, which may be indicative of a user's loss of stability while trying to deliver a command or other loss of control, then the virtual control system 34 may perform a homing-type or command reduction action. This is shown in FIG. 13 by the virtual control system 34 sending a command to the propulsion system 18 to maintain the idle speed of engine 20 and shift transmission 24 back into its neutral range, placing the propulsion system 18 into a stand-by state.

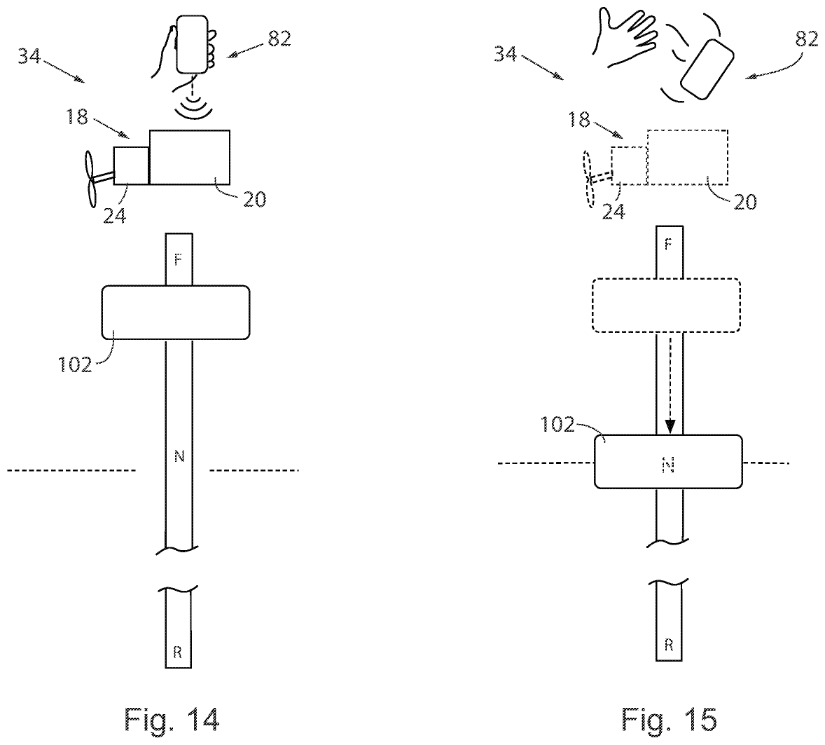

Referring now to FIGS. 14-15, some anomalous potential command inputs and other touch screen characteristics may have values that are sufficiently outside of ranges of acceptable values that the virtual control system 34 will remove control from the touch screen 82, placing it in its control-disabled mode. FIG. 14 shows the touch screen 82 in its control-enabled mode, maintaining an operational command(s) to the propulsion system 18 with the transmission in its forward range and the engine operating at an RPM that corresponds to the position of the virtual control lever 102 within its forward range of motion. Referring to FIG. 15, if the user drops the touch screen 82, the virtual control system 34 recognizes this touch screen dropped event based on, for example, a signal from the touch screen's GPS, accelerometer, and/or other sensor. When the virtual control system 34 recognizes the touch screen dropped event, the virtual control system 34 sends a control-removal command that instructs the touch screen 82 to enter its control-disabled mode and instructs the propulsion system 18 to enter its stand-by state, commanding the prime mover and transmission device into predefined states. Depending on the prime mover's and transmission device's configuration(s), this may include shifting the transmission 24 into its neutral range and reducing the speed of prime mover 20 to idle. This may instead or further include commanding the propulsion system 18 to enter a station keeping mode in which the vessel's location and/or heading is automatically maintained until a user actively resumes control or confirms control of the vessel to exit the touch screen's control-disabled mode.

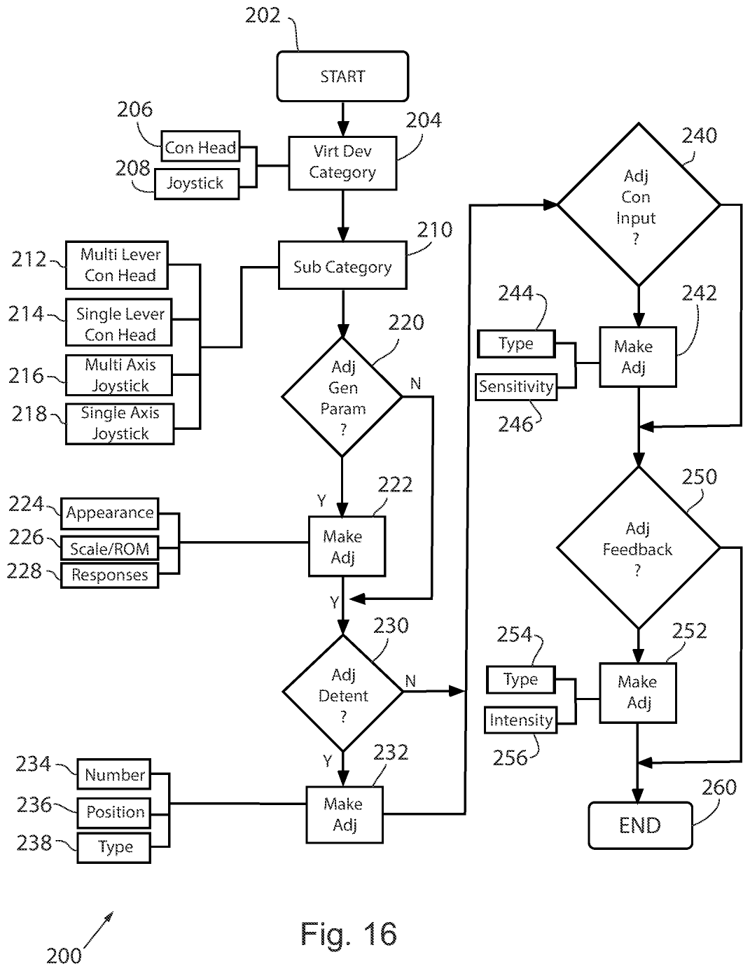

Referring now to FIG. 16 and with background reference to FIGS. 2-10, the virtual control system 34 is configured to allow modifying the operational characteristics and appearance of the virtual control devices 90, 92, 94, including modifying their GUIs 84A, 84B, 84C, interface manipulation requirements and characteristics of the virtual detents and feedback. This is schematically shown in the flowchart as process 200 that is typically implemented through corresponding GUI pages that are displayed on the touch screen 82 and are configured for setup or modification of features or aspects of the virtual control devices 90, 92, 94. The various procedures performed or user inputs made during process 200 typically involve touch-type engagements with the touch screen 82, such as tapping, dragging, or the like, which is detected by the virtual control system 34 to execute the corresponding command to effectuate the setup or modification.

Still referring to FIG. 16, process 200 starts at block 202. The user selects the virtual device category to be modified as represented at block 204, such as a virtual control head at block 206 and a virtual joystick at block 208. At block 210, a subcategory of virtual control device may be selected. Virtual control heads may include subcategories of multi-lever control heads at block 212 or single lever control heads at block 214. Virtual joystick control devices may include multi axis joysticks and single axis joysticks, as represented at blocks 216, 218. For each selected virtual control device, its individual appearance and operational characteristics may be modified.

Still referring to FIG. 16, as represented at blocks 220, 222, a user may modify general parameters of the virtual control device. This may include making adjustments that change the general appearance characteristics of the virtual control device. Examples include modifying as color and general feature layout in its GUI at block 224. Other more detailed aspects may be modified for features of the virtual control device, such as scale or resolution of movement paths for moveable GUI features or their respective start/end or max/min positions and corresponding ranges of motion, as represented at block 226. At block 228, the virtual control device's responses to application and removal of, e.g., control inputs can be adjusted. This may include choosing whether the various control features act momentary or continuous devices, and whether movable features automatically return-to-center or another home position upon cessation of a command input or some other event. An example is selecting between a return-to-center joystick mode and a no-return-to-center joystick mode. Another example includes passive feature relocation, which “jumps” a virtual control feature to match a position of the user's finger(s), such as automatic relocation of a joystick or other virtual control feature to center it at a user's finger or center it between a user's spread apart fingers.

Still referring to FIG. 16, a user may adjust characteristics of the virtual detents implemented with the respective virtual control devices, as represented at blocks 230, 232. At blocks 234, 236 a user may change the number of virtual detents implemented by each virtual control device and where the virtual detents are positioned and, correspondingly, where moveable feature will be held by such detent(s). At block 238, the type of virtual detent may be changed. This may include changing the type of user input or interaction that is required to overcome the virtual detent. Examples include touching with a minimum number of fingers such as at least two fingers, pushing with a certain force for force-sensitive touch screens, time-related aspects such as press/touch and hold momentary input, repeated or sequence requirements such as continuous or other multiple taps in a given area, continuous hold areas requiring constant touch input with one finger and control manipulation with another finger that may be at a different location, dragging finger along a certain path, such as an illustrated path on the GUI to trace.

Still referring to FIG. 16, at blocks 240, 242, required characteristics of the control input may modified. At block 244, the type of input may be selected, such as one-finger dragging, two finger twisting, tapping. Associated actions may also be (re) defined for the selected input. An example is a return to center or home position action for a virtual control feature in response to a particular input, such as a particular multiple tap sequence. At block 246, sensitivity requirements may be adjusted for the various inputs. This may include, for example, adjusting time delays between the virtual control system receiving a command input and executing a corresponding commanded operation of the propulsion system. Another example is defining boundaries of acceptable zones of interaction, such as acceptable sliding path zones, which may be used by the virtual control system to distinguish between intended command inputs and accidental touches or other engagements with the touch screen.

Still referring to FIG. 16, feedback characteristics can be modified, as represented at blocks 250, 252. At blocks 254, 256, the type and intensity of feedback can be selected and modified for different states or events. Examples of different types of feedback include haptic feedback that can be felt, audible feedback that can be heard, or visual feedback that can be seen by the user, typically delivered through the touch screen. Multiple types of feedback and/or varying intensities of feedback can be selected to convey, for example, different positional information about the virtual control devices or corresponding actions. One example is that a different type and/or intensity of feedback may be delivered for a detent-overcoming input than for control input, as well as to correspond to positional movement of the control device's movable virtual features. When the user is satisfied with the various parameter, detent, input, and feedback adjustments, the user inputs the same into the touch screen and the virtual control system saves such changes to implement any updated GUIs or control strategies and the process may end at block 260.

Although the best mode contemplated by the inventors of carrying out the present invention is disclosed above, practice of the above invention is not limited thereto. It will be manifest that various additions, modifications, and rearrangements of the features of the present invention may be made without deviating from the spirit and the scope of the underlying inventive concept.

We claim:

1. A propulsion control system for controlling operations of a marine vessel propulsion system that includes a prime mover and a power transmission device that are configured to propel a marine vessel, the propulsion control system comprising:
a physical control system that includes:
a physical control device with a movable control mechanism that can move through a range of motion and communicates with the marine vessel propulsion system to control at least one of the prime mover and the power transmission device to correspond to movements of the moveable control mechanism;
a detent that holds the movable control mechanism at a detent position within the range of motion with a detent holding force that requires an application of greater force to move the movable control mechanism from the detent position than to move the movable control mechanism through a remainder of the range of motion;
a virtual control system with a touch screen having a GUI (graphical user interface) that displays:
a virtual control device with a virtual movable control mechanism that can move through a virtual range of motion in response to a control input that is delivered through the touch screen, wherein the virtual control device communicates with the marine vessel propulsion system to control at least one of the prime mover and the power transmission device to correspond to movements of the virtual movable control mechanism; and
a virtual detent that holds the virtual movable control mechanism at a virtual detent position until application of a detent-overcoming input that is delivered through the touch screen.

2. The propulsion control system of claim 1, wherein the control input and the detent-overcoming input are defined by different touch engagement characteristics at the touch screen that correspond to a different number of fingers that provide the control input and the detent-overcoming input.

3. The propulsion control system of claim 2, wherein the virtual control system provides feedback that conveys position information relating to the virtual movable control mechanism.

4. The propulsion control system of claim 3, wherein the feedback includes detent feedback that indicates when the virtual movable control mechanism moves out of the virtual detent position.

5. The propulsion control system of claim 4, wherein the feedback includes control position feedback that indicates a position of the virtual movable control mechanism outside of the virtual detent and along the virtual range of motion.

6. The propulsion control system of claim 5, wherein the virtual control system provides the feedback as at least one of an audible notification, a visual notification, and a haptic notification.

7. The propulsion control system of claim 1, wherein:
the virtual control device is a virtual control head; and
the virtual movable control mechanism is a virtual lever that is presented on the GUI as an image of a lever.

8. The propulsion control system of claim 1, wherein:
the virtual control device is a virtual joystick device; and
the virtual movable control mechanism is a virtual joystick that is presented on the GUI as an image of a multi axis joystick.

9. The propulsion control system of claim 1, wherein:
the virtual control device is a virtual joystick device; and
the virtual movable control mechanism is a virtual joystick that is presented on the GUI as an image of a single axis joystick.

10. A propulsion control system for controlling operations of a marine vessel propulsion system that includes a prime mover and a power transmission device that are configured to propel a marine vessel, the propulsion control system comprising:
a physical control system with a set of physical movable control mechanisms that are configured to be actuated by a user as physical control commands to control the operations of the marine vessel propulsion system;
a virtual control system with an HMI (human machine interface) that includes a touch screen that is configured to display a set of virtual movable control mechanisms and to receive touch-based inputs from the user as virtual control commands to control the operations of the marine vessel propulsion system; and
wherein the propulsion control system is configured to:
identify touch-based engagements of the set of virtual control devices as potential command inputs; and
evaluate the potential command inputs to determine whether each potential command input is:
a true command input that corresponds to a desired command from the user to control an operation of the marine vessel propulsion system; or
a null command input that corresponds to an ancillary touch-based engagement of the touch screen that does not correspond to a desired command from the user.

11. The propulsion control system of claim 10, wherein:
the physical control system includes a control head and wherein:
the set of physical movable control mechanisms includes a lever that is pivot mounted to the control head;
the lever defines a neutral position and from which the lever can be moved through a lever range of motion;
a detent holds the lever in the neutral position and is configured to require a greater force to move the lever away from the neutral position than is required to move the lever through the reminder of the lever range of motion;
the virtual control system includes a virtual control head and wherein:
the set of virtual movable control mechanisms includes a virtual lever of the virtual control head as an image that can be dynamically repositioned through touch-based engagements of the virtual lever through the touch screen to move the virtual lever through a virtual lever range of motion;
a virtual detent requires a different characteristic of the touch-based engagements of the virtual lever to move the virtual lever past the virtual detent than is required to move the virtual lever through the remainder of the virtual lever range of motion.

12. The propulsion control system of claim 11, wherein the virtual control system provides detent feedback to the user as at least one of an audible notification, a visual notification, and a haptic notification when the virtual lever is moved past the virtual detent.

13. The propulsion control system of claim 12, wherein the virtual control system provides control position feedback to the user as at least one of an audible notification, a visual notification, and a haptic notification with a characteristic that increases as the virtual lever is moved through the virtual lever range of motion.

14. The propulsion control system of claim 13, wherein as the virtual lever is moved further through the virtual lever range of motion, virtual control system provides control position feedback to the user as at least one:
an increasing volume of repeating audible notifications;
an increasing strobe frequency of a displayed light or image;
an image or color that changes as a function of the position of virtual lever; and
an increasing frequency or intensity of a haptic notification.

15. The propulsion control system of claim 10, wherein:
the set of physical movable control mechanisms includes a joystick device with a base and a joystick that is moveable with respect to the base by at least one of forward/backward translation, side-to-side translation, and rotation, to control the operations of the marine vessel propulsion system;
the set of virtual movable control mechanisms includes a virtual joystick device that has a virtual joystick as an image that can be dynamically repositioned through touch-based engagement with the touch screen to respectively control the operations of the marine vessel propulsion system according to corresponding movements of the joystick of the set of physical control devices.

16. The propulsion control system of claim 10 wherein:
the user touch screen is a smart device that wirelessly communicates within the virtual control system; and
the virtual control system is configured to detect a touch screen dropped event that corresponds to a user dropping the smart device and upon detection of the touch screen dropped event, issue a control-removal command to the marine vessel propulsion system that commands the marine vessel propulsion system to enter a stand-by state.

17. The propulsion control system of claim 16 wherein commanding the marine vessel propulsion system to enter a stand-by state includes commanding each of the prime mover and the transmission device to enter a predefined state.

18. The propulsion control system of claim 17, wherein the predefined states include shifting the transmission into its neutral range and reducing the speed of the prime mover to idle.
